(19) United States
(12) Patent Application Publication
(10) Pub. No.: US 2011/0291797 A1
(43) Pub. Date: Dec. 1, 2011

(54) BYPASS SYSTEM AND METHOD FOR THE REMOTE START OF A VEHICLE

(76) Inventors: Martin TESSIER, Mascouche (CA); Partrick Noel, Mascouche (CA); Jean-Pierre Aubertin, Laval (CA); Cristinel Zaharia, Montreal (CA); Duc Minh Cong Nguyen, Montreal (CA)

(21) Appl. No.: 12/791,247

(22) Filed: Jun. 1, 2010

(51) Int. Cl. G06F 7/04

(52) U.S. Cl. 340/5.61

(57) ABSTRACT

A bypass module for bypassing an immobilizer of a vehicle. The immobilizer includes a transceiver for transmitting a security information request and receiving security information from a vehicle transponder key. The bypass module includes a first communication interface for interfacing with the immobilizer, a controller for processing the security information request; and a memory for storing the security information. The vehicle immobilizer of the vehicle is bypassed when the bypass module transmits via said first communication interface the security information stored on the memory to the immobilizer in response to the security information request.

### FIELD OF THE INVENTION

The present invention relates to a system and method for preventing the unauthorized bypass of an OEM immobilizer security system used in conjunction with a remote vehicle starter. More specifically, the present invention relates to an interface module between a remote vehicle starter and an OEM immobilizer security system capable of responding to the security requests of an OEM immobilizer security system to permit bypass of the immobilizer security system.

### BACKGROUND OF THE INVENTION

Remote vehicle starters are a convenient way for vehicle owners to start their vehicles from a distance without having to introduce a key into the vehicle's ignition. Typical remote vehicle starters comprise a portable radio frequency transmitter capable of transmitting a start signal to a vehicle starter located within a vehicle, wherein the vehicle starter is capable of starting the vehicle upon reception of a start signal from the transmitter.

However, many vehicles manufactured with original equipment manufacture (OEM) security systems, such as immobilizers, prevent remote starting. Such OEM security systems typically require a code or security key to be furnished in order to authenticate the identity of a vehicle's user prior to an engine start which is typically recorded on a vehicle's immobilizer or OEM security system. Upon an attempted vehicle start, the OEM security system must be provided this security code for successful vehicle ignition. An example of such an immobilizer system is Ford Motor Company's SecuriLock, also known as Passive Anti-Theft System (PATS). In such a system, the security code is stored on an embedded transponder located within the vehicle ignition key. When a vehicle having this system is started with such a transponder ignition key, a vehicle's on-board computer or immobilizer transmits a radio frequency (RF) signal via a transceiver that is received by the transponder embedded within the key. The transponder then generates and transmits a unique modulated RF reply signal containing the security code in response to the vehicle's RF signal. The modulated RF signal is demodulated by the transceiver and then processed to extract the code which is verified with the code previously stored on the vehicle's computer. If the codes match, authentication of the key is positively identified and ignition is commenced. More modern OEM security systems further employ encrypted RF signals along with challenge/response protocols that require a transponder to return a response consisting of a function of the answer to the question from the challenge in addition to a security code.

Aftermarket remote vehicle starters are unable to respond to such immobilizer security requests as the ignition key bearing a transponder is not within physical proximity of the vehicle's computer, or immobilizer's RF transceiver. In order for aftermarket remote car starters to function in the presence of immobilizers, they must be installed with immobilizer bypass kits able to satisfy the OEM security system's code and challenge requests in the same manner as if an OEM transponder ignition key were present. Typically, such bypass kits are used in conjunction with remote starters by acting as an intermediary between a remote starter and a vehicle's immobilizer system. In operation of a bypass kit, a remote starter transmitter transmits an engine start signal to the remote starter installed in a vehicle. Upon reception, a start signal is sent to a security bypass kit, which in turn transmits to the OEM security system the required ignition request and code/response necessary to engage the vehicle's ignition.

Existing transponder-based bypass kits require an original vehicle transponder key to be within close physical proximity of the immobilizer system's transceiver, for example beneath the vehicle's dashboard, such that upon a remote start request to the bypass kit, the bypass kit is capable of emulating the transponder in the key to capture and transmit the security information residing on the vehicles transponder key to the vehicle's immobilizer each time a remote start request is made. However, these conventional aftermarket remote starter immobilizer bypass kits can be exploited by thieves to easily circumvent the OEM security system. By having to physically place the immobilizer bypass transponder near immobilizer's transceiver, typically located on the steering column of the vehicle, a thief simply can locate the transponder beneath the vehicle's dashboard and use it to engage the vehicle.

Therefore, there is a need for securing vehicle transponder-based bypass kits against these types of theft. Accordingly, there is provided a method which addresses the above mentioned shortcomings by eliminating the storage of a transponder beneath a vehicle's dashboard.

Additionally, existing transponder-based bypass kits which have been previously programmed with security information particular to a vehicle are not interchangeable with other vehicle types unless the bypass kit undergoes reprogramming for a new vehicle's code and challenge. Therefore, what is also needed, and also an object of the present invention, is a bypass system that is transparent and reprogrammable to different OEM security standards and capable of emulating different vehicle ignition key transponders.

### SUMMARY OF THE INVENTION

According to the present invention, there is provided a bypass module for bypassing an immobilizer of a vehicle, the immobilizer comprising a transceiver for transmitting a security information request and receiving security information from a vehicle transponder key, the bypass module comprising:
a first communication interface for interfacing with the immobilizer;
a controller for processing the security information request; and
a memory for storing the security information;
wherein the vehicle immobilizer of the vehicle is bypassed when the bypass module transmits via said first communication interface the security information stored on the memory to the immobilizer in response to the security information request.

According to another aspect of the present invention, there is provided a method for bypassing an immobilizer of a vehicle, the method comprising:
capturing and decoding security information residing on a vehicle transponder key by means of a bypass module, said bypass module comprising a first communication interface for interfacing with the immobilizer, a controller for processing a security information request, and a memory for storing the security information;
storing said security information in a memory; and
responding to a security information request of the immobilizer by communicating said security information stored in said memory to the immobilizer; wherein the vehicle immobilizer of the vehicle is bypassed upon communication of said security information to the immobilizer.

### BRIEF DESCRIPTION OF THE DRAWINGS

In the appended drawings:

FIG. 1 is a block diagram illustrating a bypass system for the remote start of a vehicle, according to a preferred embodiment of the present invention;

FIG. 2 is a block diagram illustrating a wireless communication interface between a bypass module and a vehicle immobilizer, according to a preferred embodiment of the present invention;

FIG. 3 is a block diagram illustrating an immobilizer and transponder vehicle key based security system, according to a preferred embodiment of the present invention;

FIGS. 4A, 4B and 4C are block diagrams illustrating various embodiments of communication interfaces between a vehicle immobilizer and a bypass module; and

FIG. 5 is a flow diagram illustrating a sequence for bypassing an OEM immobilizer during a remote start employing a bypass module, according to a preferred embodiment of the present invention.

### DESCRIPTION OF ILLUSTRATIVE EMBODIMENTS

The present invention is illustrated in further detail by the following non-limiting examples.

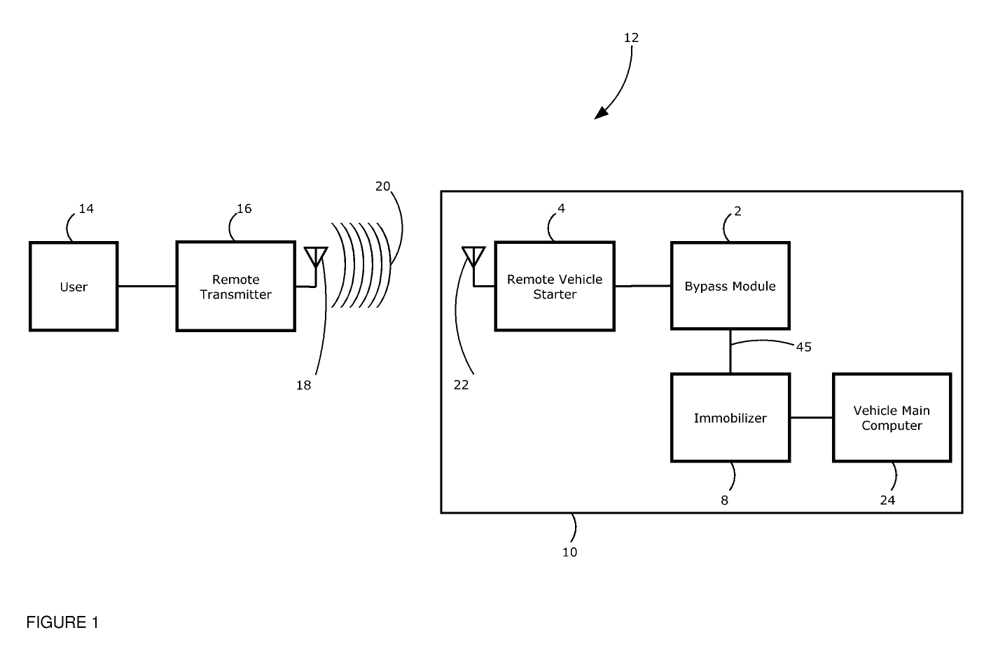

Referring to FIG. 1, a bypass system in accordance with an illustrative embodiment of the present invention will be described. The bypass module, generally referred to using the reference numeral 2, which serves to interface a remote vehicle starter 4 to a vehicle immobilizer 8 of a vehicle 10 is disclosed within the context of a remote vehicle ignition system 12. As illustrated, bypass module 2 forms part of a remote vehicle ignition system 12 comprising a user 14, a user operated remote transmitter 16 comprising a transmitter antenna 18 for signalling an ignition command over radio frequency (RF) signal 20 to a remote vehicle starter 4 comprising a receiver antenna 22, a vehicle immobilizer 8, and a vehicle computer system 24. It should be noted that although the illustrative embodiment of the present invention is described in reference to radio frequency (RF) transmitters and receivers, it is not intended to limit the invention to this type of particular wireless communication. Accordingly, the present invention may also employ, for example, microwave communication or infrared short-range communication for the transmission of signals over a wireless distance.

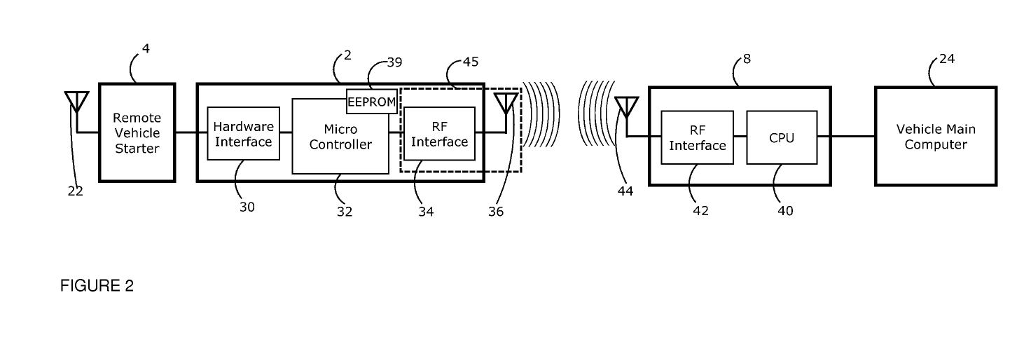

Now referring to FIG. 2, the functioning and intercommunication of the bypass module 2 within the context of a remote vehicle ignition system 12 as shown in FIG. 1 is described. The bypass module 2 is composed of a hardware interface 30 in communication with the remote vehicle starter 4, a microcontroller 32, an RF interface 34 and a bypass module antenna 36. The hardware interface 30 is the gateway between the remote starter 4 and the microcontroller 32 of the bypass module 2. In one embodiment, the bypass module 2 and its various components are housed within a plastic box containing a printed circuit having some or a plurality of connectors and one or more wire harnesses to connect the bypass module 2 to the remote starter 4. In another embodiment, the bypass module 2 is integrated within the remote vehicle starter 4.

The microcontroller 32 processes data received from the RF interface 34 as well as the hardware interface 30. It executes all the necessary calculations for the processing related to security information 38, such as a code, a unique ID, and any challenge/response protocol information, as well as various encryption algorithms, needed to interact with the immobilizer 8 and the vehicle's main computer 24. Such security information 38 is stored on a programmable memory 39, such as an EEPROM memory, located on the bypass module 2 or on the microcontroller 32. The microcontroller 32 equally reproduces the RF signals to be transmitted to the vehicle via the RF interface 34.

In addition to immobilizer bypass functions, the bypass module 2 can be also connected to a vehicle 10 to activate or monitor signals, such as lock/unlock functions, trunk opening functions and likewise.

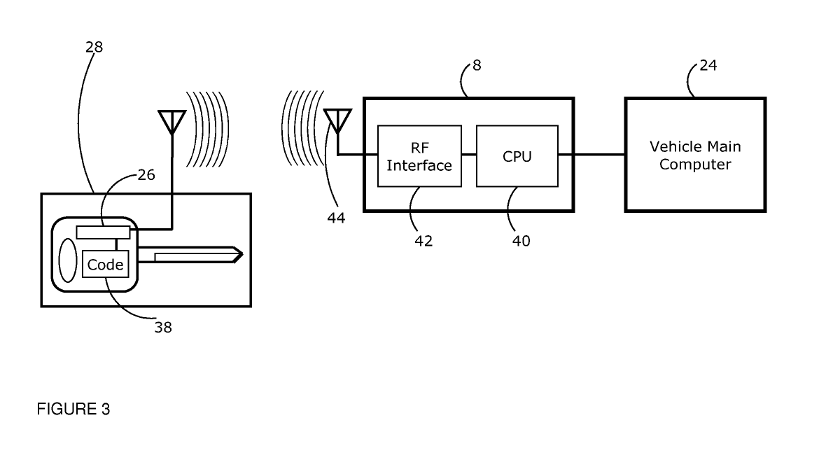

Generally, the immobilizer 8 is the electronic module that manages the security interactions between the transponder 26 of the vehicle key 28 and the vehicle computer system 24, as is illustratively shown in FIG. 3. The immobilizer 8 comprises a microprocessor or CPU 40, an RF interface 42 and an immobilizer antenna 44, or inductor. As per a different embodiment, the immobilizer antenna 44 used for RF communications can be a helical antenna, a wire, a coil or inductor or other type of antenna known to a person skilled in the art. It should be noted that although the illustrative embodiment of the present invention is described in terms of a cut vehicle key with an embedded transponder, it is not intended to limit the invention to this type of particular vehicle key. Accordingly, the present invention may also employ, for example, a smart key (in the case of Toyota) or a keyless entry with push to start functionality.

Now referring again to FIG. 2 in addition to FIG. 3, within the context of a remote vehicle ignition system 12, the immobilizer 8 communicates with a bypass module 2 requesting the security information 38, such as a code, upon an ignition request received from a remote vehicle starter 4. In more advanced OEM security systems, the immobilizer 8 may also issue a challenge. Immobilizer challenges are normally issued when a key 28 engages an ignition barrel at key in, accessory, ignition or start positions. The challenge may also be repeated many times while the vehicle 10 is started. When the immobilizer 8 receives a valid code and response, it communicates with the vehicle's computer system 24 which in turn engages the ignition of the vehicle 10. If the immobilizer 8 does not receive valid security information 38, such as a valid code or a valid challenge response, or an encrypted combination thereof, it will not communicate with the vehicle computer system 24 commanding a vehicle start.

For the microcontroller 32 to process security information 38 requests or other forms of security questions or challenges from immobilizer 8 upon an ignition request and in turn communicate the necessary security code and response, the RF interface 34 modulates and demodulates the RF signal according to the RF methods or schemes employed by the vehicle's RF interface 42. The microcontroller 32 is capable of recognizing different RF modulation and demodulation schemes of the vehicle 10 in which the bypass module 2 has been installed.

Prior to a remote vehicle start and the bypass of a vehicle immobilizer 8, the bypass module 2 must be physically installed within a vehicle 10 and programmed according to the security information 38 located on the vehicle key 28. The possession of a vehicle key 28 at the programming or installation of the bypass module 2 may be required. Indeed, the vehicle key 28 is not mandatory at installation and may be replaced by other means to achieve the same purpose. The installation of a bypass module 2 in the vehicle 10 may also require the prior installation of a remote starter 4.

Three methods to program the bypass module 2 are possible. A first method involves programming the bypass module 2 in the same manner as the vehicle manufacturer programs security information 38 within a vehicle key 28. A second method involves capturing the security 38 from the vehicle key 28 during its wireless transmission and remotely decoding the security information 38, for example by transmitting the captured code or challenge response to a remote server over the internet for it to be externally decoded and storing the decoded code on the bypass module 2. A third method for programming security information 38 on the bypass module 2 involves the bypass module 2 capturing the security information 38 by intercepting the wireless transmission of the vehicle key transponder 26 and subsequently decoding the security information, with or without the use of an external programmer or a computer and without having to communicate the captured information to a remote server. These programming methods, along with the capability of the microcontroller 32 to recognize and reproduce the different RF modulation and demodulation schemes of different vehicles 10 in which the bypass module has been installed, advantageously permits the bypass module 2 to be installed in different vehicle types. The bypass module 2 is thus capable of emulating a variety of security codes and challenge responses of different vehicle transponders 26 needed to bypass a variety of immobilizers located on different vehicle model types.

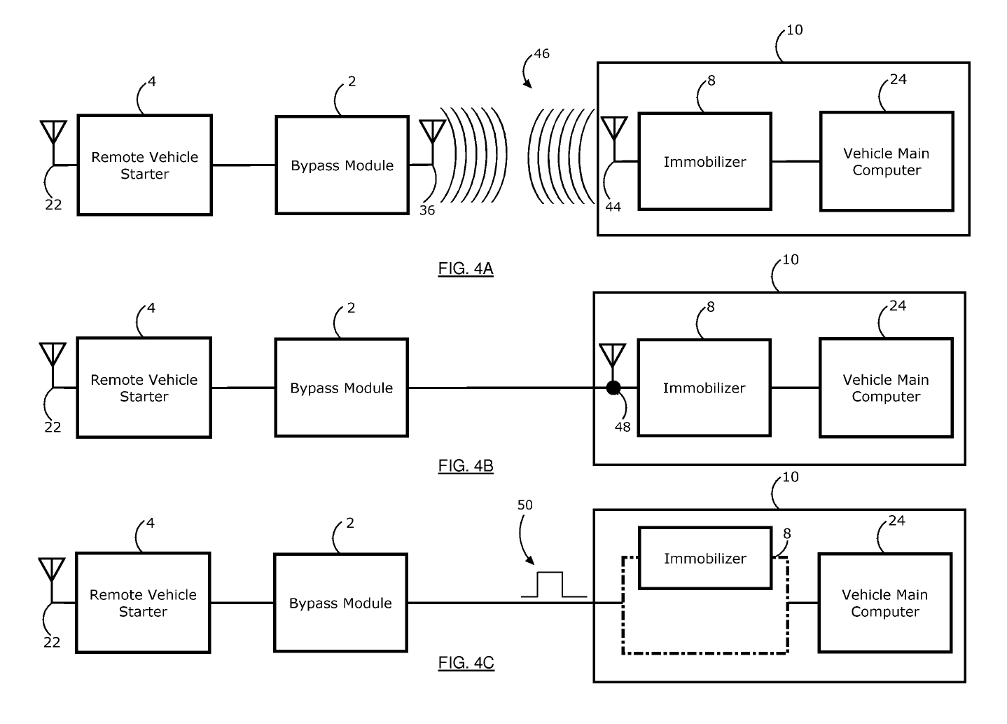

Now with referral to FIGS. 4A, 4B, and 4C, in addition to FIG. 2 and FIG. 1, the bypass module 2 may employ various types of communication interfaces 45 with the vehicle immobilizer 8 depending on the type of vehicle in which the bypass module 2 is installed. These communication interfaces 45 facilitate the adaptability of the bypass module 2 to various vehicle types. In one embodiment shown in FIG. 4A, a first interface 46 involves communication using RF transmitted by an antenna 36, a coil (inductor), or other types of circuits permitting RF communication 46. In another embodiment shown in FIG. 4B, a second interface involves communication by coupling 48 directly in series or in parallel on the vehicle's RF communication wires or antennas 44 depending on the vehicle's security system. A third interface shown in FIG. 4C, involves digital communication 50, in which a communication link with a vehicle's data lines is established to permit direct communication with the immobilizer 8 and the main computer of the vehicle 24. Employing digital communication 50 avoids use of the RF communication 46 where RF communication is more subject to noise.

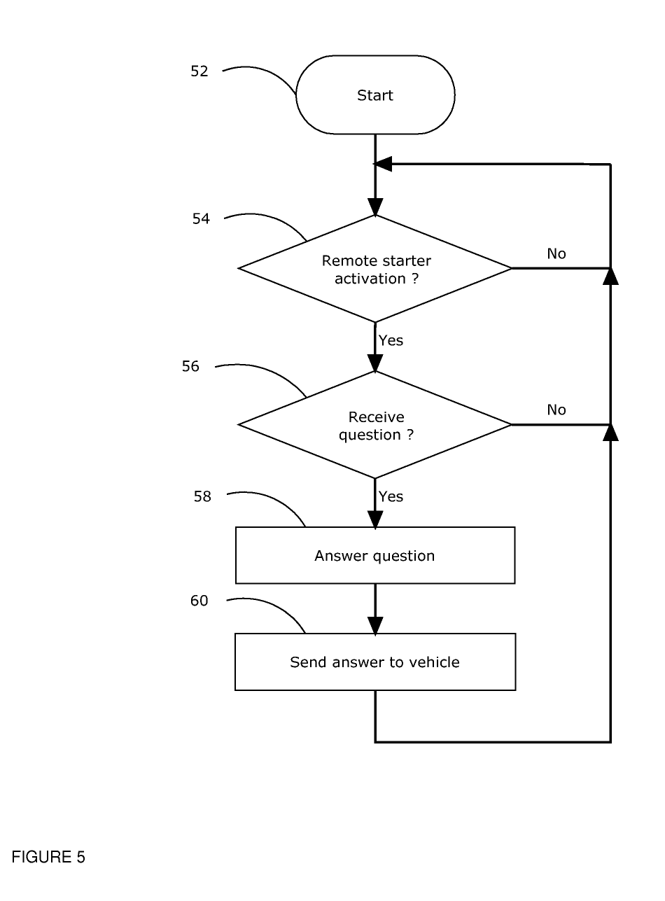

A remote start of a vehicle employing a bypass module 2 will now be described with referral to FIG. 5. The remote starter 4 receives a start 52 command from the user 12, which in turn sends a start signal to the vehicle main computer 24 to engage ignition. The bypass module 2 is then Activated 54 by one or more negative or positive polarity signals connected to the bypass module 2. In another embodiment, a serial data communication link connects the remote starter 4 and the bypass module 2 such that a data command may alternatively Activate 54 the bypass module 2. It is at this point that the bypass module 2 enters Read 56 mode and waits to receive the security information requests of the immobilizer 8. In particular, the bypass module 2 demodulates the RF signal transmitted from the immobilizer 8 and the microcontroller 32 analyses and decodes the signal containing the security information request. Subsequently, the bypass module 2 Answers 58 the security information request of the immobilizer 8 and Returns 60 the appropriate information requested by immobilizer 8, such as a code, a challenge response, or a response based on the encrypted function output of a code and a challenge response. The Return 60 communication exchanged between the bypass module 2 and the immobilizer 8 may further be encrypted. The present invention, therefore, emulates a vehicle key 28 bearing a transponder 26 to thus permit the remote start of a vehicle.

In an alternative embodiment of the present invention, the bypass module 2 replaces the transponder vehicle key 28 so that a user 14 can bypass the immobilizer 8 of a vehicle 10 in situations where a remote car starter 4 is not installed. Such an embodiment would permit a non-transponder vehicle key from being used to start a vehicle 10 and would permit a user 14 to easily make a copy of such a key at a local hardware store without the need of having to return to the manufacturer to obtain a transponder key having a code 38 or to reprogram the immobilizer 8 with different security information 38.

Although the present invention has been described hereinabove by way of embodiments thereof, it may be modified, without departing from the nature and teachings of the subject invention as defined in the appended claims.

1. A bypass module for bypassing an immobilizer of a vehicle, the immobilizer comprising a transceiver for transmitting a security information request and receiving security information from a vehicle transponder key, the bypass module comprising:
a first communication interface for interfacing with the immobilizer;
a controller for processing the security information request; and
a memory for storing the security information;
wherein the vehicle immobilizer of the vehicle is bypassed when the bypass module transmits via said first communication interface the security information stored on the memory to the immobilizer in response to the security information request.

2. The bypass module of claim 1, further comprising a second communication interface for interfacing with a remote starter of the vehicle, wherein the controller monitors said first communication interface for the security information request upon receiving a remote start signal from said remote starter via said second communication interface.

3. The bypass module of claim 1, wherein said first communication interface comprises a radio frequency interface and an antenna connected to the radio frequency interface for communication with an antenna of the immobilizer.

4. The bypass module of claim 1, wherein said first communication interface comprises a radio frequency interface and a radio frequency inductor for coupling to an antenna of the immobilizer.

5. The bypass module of claim 3, wherein said controller recognizes via said first communication interface a modulation and demodulation scheme employed by the vehicle immobilizer and communicates with the immobilizer by means of said modulation and demodulation scheme.

6. The bypass module of claim 4, wherein said first communication interface communicates with the vehicle immobilizer using a modulation and demodulation scheme employed by the vehicle immobilizer.

7. The bypass module of claim 1, wherein the security information residing on the vehicle transponder key is programmed in said memory prior to bypassing the vehicle immobilizer of the vehicle.

8. The bypass module of claim 1, wherein the bypass module captures and decodes the security information residing on the vehicle transponder key and programs the security information in said memory prior to bypassing the vehicle immobilizer of the vehicle.

9. The bypass module of claim 1, wherein the security information residing on the vehicle transponder key is captured by the bypass module, decoded by a remote server and programmed in said memory prior to bypassing the vehicle immobilizer of the vehicle.

10. The bypass module of claim 1, wherein the security information is encrypted by the controller prior to transmission to the immobilizer.

11. A method for bypassing an immobilizer of a vehicle, the method comprising:
capturing and decoding security information residing on a vehicle transponder key by means of a bypass module, said bypass module comprising a first communication interface for interfacing with the immobilizer, a controller for processing a security information request, and a memory for storing the security information;
storing said security information in a memory; and
responding to a security information request of the immobilizer by communicating said security information stored in said memory to the immobilizer;
wherein the vehicle immobilizer of the vehicle is bypassed upon communication of said security information to the immobilizer.

12. The method of claim 11, further comprising monitoring said first communication interface of the bypass module for said security information request upon receiving a remote start signal from a remote starter prior to responding to said security information request.

13. The method of claim 12, wherein said first communication interface comprises a radio frequency interface and an antenna connected to the radio frequency interface for communication with an antenna of the immobilizer.

14. The method of claim 12, wherein said first communication interface comprises a radio frequency interface and a radio frequency inductor for coupling to an antenna of the immobilizer.

15. The method of claim 12, wherein a controller recognizes via said first communication interface a modulation and demodulation scheme employed by the vehicle immobilizer and communicates with the immobilizer by means of said modulation and demodulation scheme.

16. The method of claim 11, wherein the security information residing on the vehicle transponder key is programmed in said memory prior to bypassing the vehicle immobilizer of the vehicle.

17. The method of claim 11, wherein the bypass module captures and decodes the security information residing on the vehicle transponder key and stores the security information in said memory prior to bypassing the vehicle immobilizer of the vehicle.

18. The method of claim 11, wherein the security information residing on the vehicle transponder key is captured by the bypass module, decoded by a remote server and stored in said memory prior to bypassing the vehicle immobilizer of the vehicle.

19. The method of claim 11, wherein the security information is encrypted by the controller prior to responding to a security information request of the immobilizer.
